(19) United States
(12) Patent Application Publication
(10) Pub. No.: US 2004/0244117 A1
(43) Pub. Date: Dec. 9, 2004

(54) Gardening tool with multiple interchangeable tool heads

(76) Inventor: Hsiu-Hua Huang, Changhua County (TW)

Correspondence Address: BIRCH STEWART KOLASCH & BIRCH, PO BOX 747, FALLS CHURCH, VA, 22040-0747, US

(21) Appl. No.: 10/454,687

(22) Filed: Jun. 5, 2003

(51) Int. Cl. A01B 1/00

(52) U.S. Cl. 7/114

(57) ABSTRACT

The invention provides a gardening tool with multiple interchangeable tool heads, which includes a grip handle and a connecting head that is located at one end of the grip handle, wherein a plurality of fastening holes is provided at the front side and the lateral side of the connecting head. Besides, a specific tool can be provided at each of the two sides of the first tool head, whereas another specific tool can be provided at the front side of the second tool head. Despite that the tool head may be different, a connecting portion will be provided on each tool head, and a plurality of holes is provided on the connecting portion so that a plurality of fastening elements can be inserted into the holes to fix the connecting portion onto the front end or the side face of the connecting head. Thus, a plurality of tool heads is interchangeable for different usages by being assembled to and disassembled from the connecting head of the grip handle.

### FIELD OF THE INVENTION

The invention relates to a gardening tool and, more particularly, to a gardening tool with multiple interchangeable tool heads that have different functions and can be assembled to and disassembled from the gardening tool.

### BACKGROUND OF THE INVENTION

A common gardening tool, such as a rake, a hoe, a saw, or an axe, mostly includes a grip handle for gripping and a tool head (such as the aforementioned rake, hoe, etc.) that is fastened onto the front end of the gripping handle for a particular function. Therefore, it is often necessary for a user to prepare at least five or six kinds of gardening tools before he/she is ready to work in a vegetable or flower garden so that different jobs such as soil loosening, soil digging, weeding, wood chopping and so on can be handled properly. However, buying, carrying, and storing all these gardening tools can also mean labor consuming and cost ineffective.

### SUMMARY OF THE INVENTION

To cope with the above-mentioned problem, a gardening tool with multiple interchangeable tool heads provided by the invention includes a grip handle and a connecting head that is located at one end of the grip handle. Besides, a plurality of fastening holes is provided at the front side and the lateral side of the connecting head. In addition, a tool head is also included, and a specific tool with specific usage is provided at each of the two sides of the tool head. On the other hand, another kind of tool head can also be provided, and, in such case, a specific tool with specific usage can be extended from the front side of the tool head. However, despite that the tool head may be different, a connecting portion is provided on each tool head, and a plurality of holes is provided on the connecting portion so that a plurality of fastening elements can be inserted into the holes to fix the connecting portion onto the front end or the side face of the connecting head. Thus, a plurality of tool heads is interchangeable for different usages by being assembled to and disassembled from the connecting head of the grip handle.

### BRIEF DESCRIPTION OF THE DRAWINGS

FIG. 1A is an exploded perspective view of the first embodiment of the invention.

FIG. 1B is a partially sectional view of FIG. 1 after assembling.

FIG. 2 is an exploded perspective view of the second embodiment of the invention.

FIG. 3 is an exploded perspective view of the third embodiment of the invention.

FIG. 4 is an exploded perspective view of the fourth embodiment of the invention.

FIG. 5 is a schematic view of a hoe head of the invention to be assembled for use.

### DETAILED DESCRIPTION OF THE PREFERRED EMBODIMENTS

The objects and technical contents of the invention will be better understood through the description of the following embodiments with reference to the drawings.

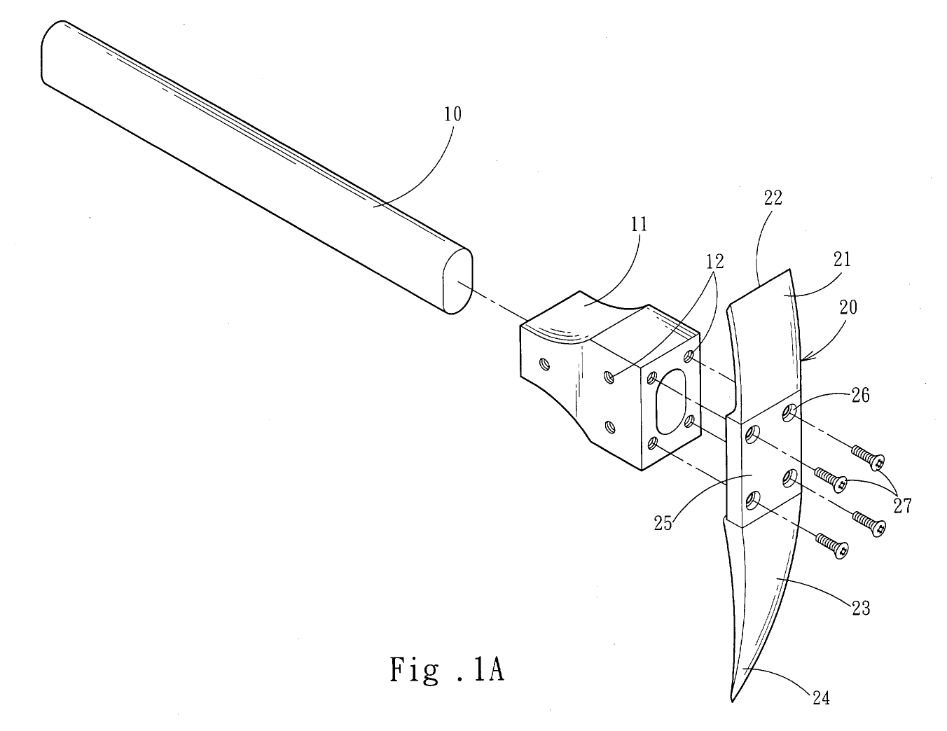

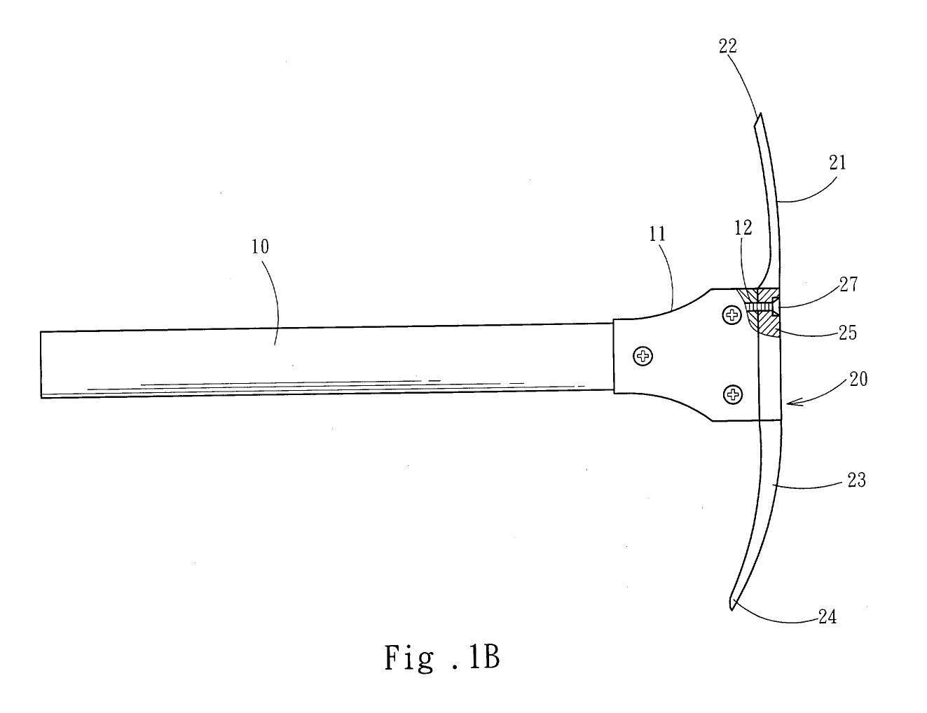

Referring to FIGS. 1A and 1B, the gardening tool with multiple interchangeable tool heads of the invention includes:

a pole-shaped grip handle 10 and a connecting head 11, wherein the connecting head is made of metal and to be sleeved onto the front end of the grip handle 10; besides, the front end of the connecting head 11 is a square shape, and in order to be fitted into the grip handle 10 at the other end of the connecting head 11, the connecting head 11 is formed extending from its front end to the opposite end in a diminishing manner so that the side faces of the connecting head 11 all have a shape of trapezoid; also, four fastening holes 12 are provided at the front end face of the connecting head 11, and three fastening holes 12 are also provided at one of the side faces of the connecting head 11;

a first tool head 20 made of metal, wherein a hoe head 21 is provided at one side of the first tool head 20, and a hoe blade 22 of the hoe head 21 is provided perpendicular to the grip handle 10; in addition, a pickaxe head 23 is provided on the other side of the tool head 20, and a pickaxe blade 24 used for digging is provided perpendicular to the grip handle 10; also, a connecting portion 25 is located between the hoe head 21 and the pickaxe head 23, wherein four fisheyes 26 are provided at the bottom face of the connecting portion 25 to be inserted into by fastening elements 27 so that the tool head 20 can be fastened onto the connecting head 11 of the grip handle 10;

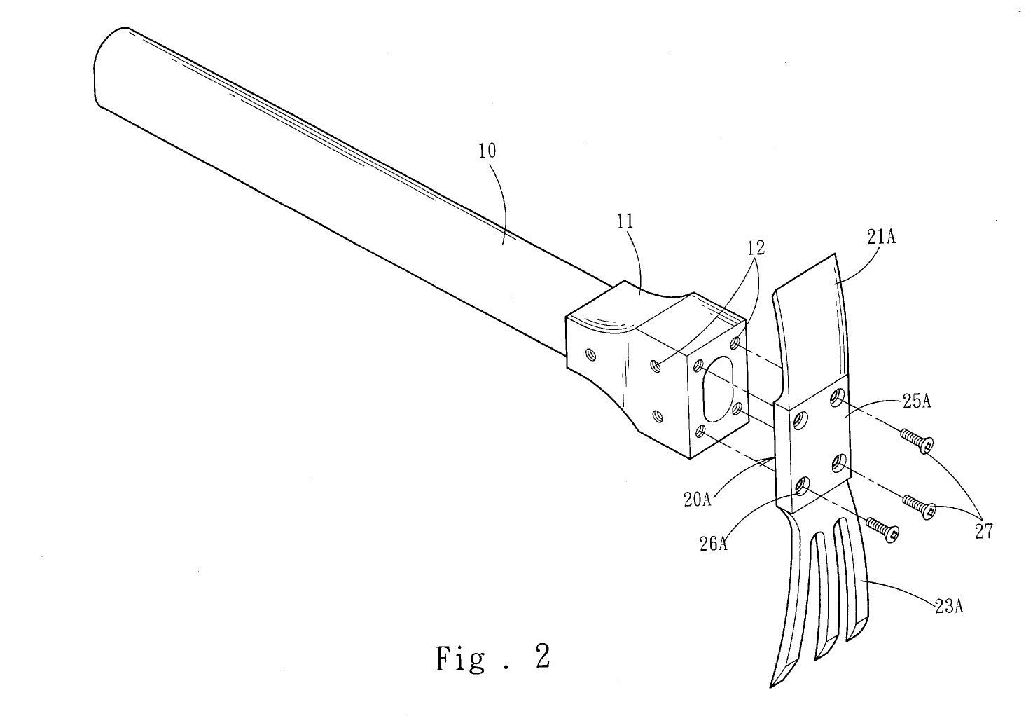

Alternatively, as shown in FIG. 2, instead of the hoe head 20 shown in FIG. 1A, a hoe head 21A can be provided at one side of the connecting portion 25A of the first tool head 20A. Besides that, instead of the pickaxe head 23 shown in FIG. 1A, a rake head 23A can be provided on the other side of the connecting portion 25A. Nevertheless, the structure of the connecting portion 25A in FIG. 2 is the same as that of the connecting portion 25 in FIG. 1A, which means four fisheyes 26A are also provided on the connecting portion 25A.

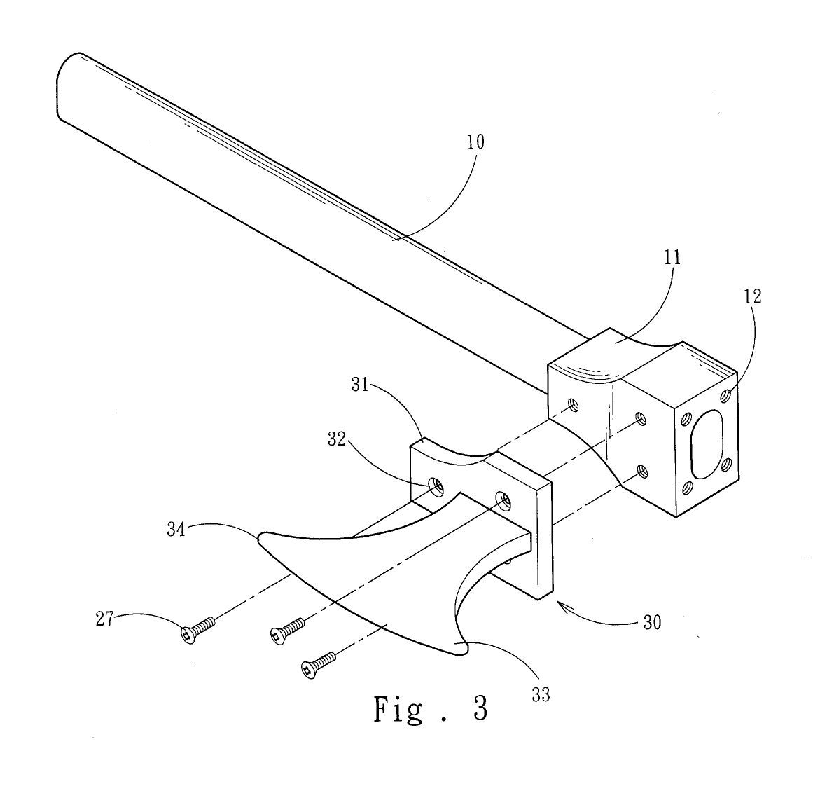

On the other hand, another kind of tool head 30 can also be provided, as shown in FIG. 3. Referring to FIG. 3, a second kind of tool head 30 is provided with a sheet of connecting portion 31, and three fisheyes 32 are provided on the connecting portion 31. Besides, a specific tool such as an axe head 33 is provided extending from the direction facing the three fisheyes 32, wherein the axe blade 34 of the axe head 33 is provided parallel to the grip handle 10. Each of the three fisheyes is to be inserted in by a fastening element 27 such as a screw so that the second tool head 30 can be fastened onto the connecting head 11 of the grip handle 10.

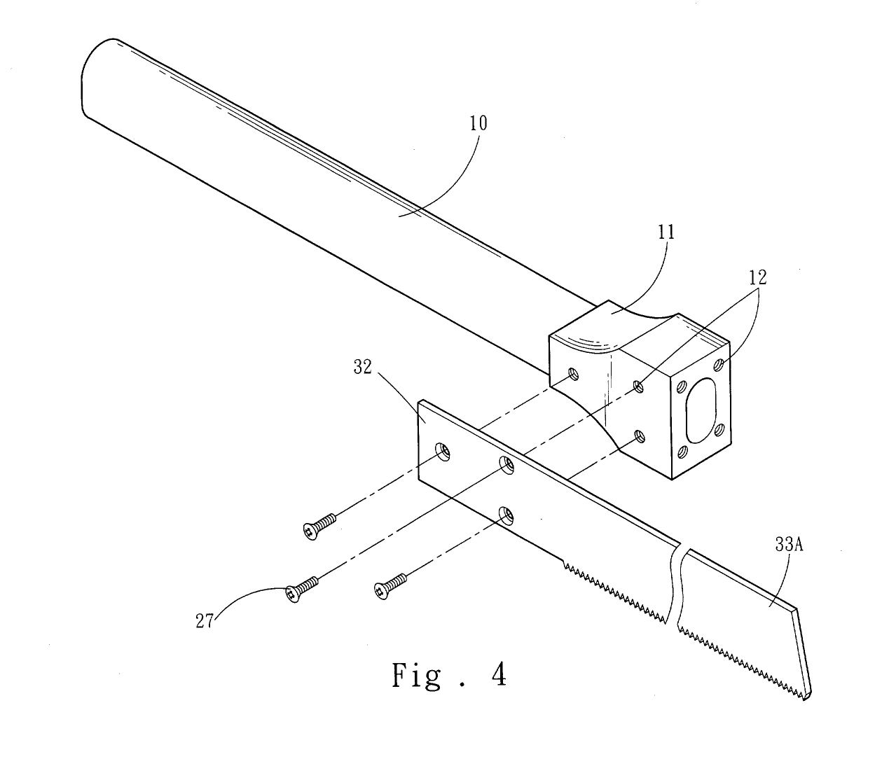

Alternatively, referring to FIG. 4, the aforementioned second tool head 30 can be replaced by a piece of saw head 33A. In that case, one end of the saw head 33A will be a connecting portion provided with three fisheyes 32, wherein each fisheye 32 will be penetrated by a fastening element 27. Then, by screwing the fastening elements into their corresponding fastening holes 12, the connecting portion can be screwed onto the connecting head 11. By doing so, the saw head 33A will be parallel to the grip handle 10.

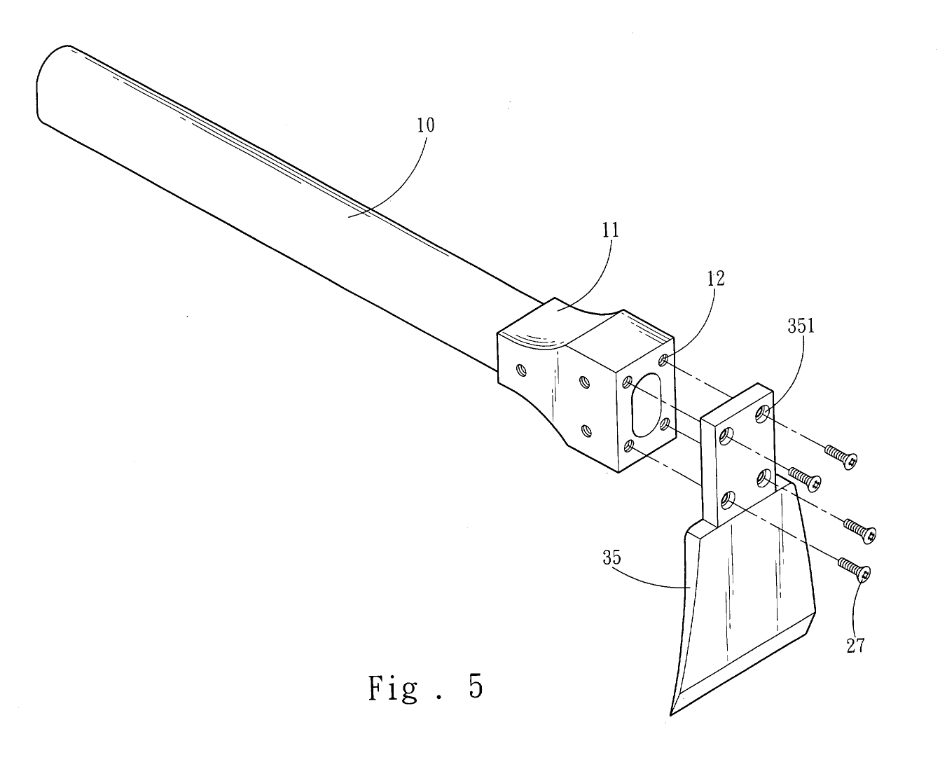

Finally, as shown in FIG. 5, which is a schematic view of a hoe head 35 of the invention to be assembled like a conventional hoe, the fisheyes 351 of the hoe head 35 will first be penetrated by fastening elements 27, and then the hoe head 35 will be fastened onto the connecting head 11 through the fastening holes 12.

According to the above-mentioned structure, the connecting head 11 at the front end of the grip handle 10 is utilized so that the first tool head 20, 20A can be fastened onto the front end of the connecting head 11. Then, a specific tool such as a hoe head 21, 21A, a pickaxe head 23, or a rake head 23A can be provided at each of the two sides of the tool head 20, 20A. Also, the fastening elements 27 will be used to fasten the first tool head 20, 20A onto the grip handle 10 to complete a gardening tool for soil loosening, weeding, and so on.

Alternatively, a second tool head 30, 30A can be fastened onto the side face of the connecting head 11. Then, the side face of the connecting head 11 will be facing to a specific tool such as an axe head 33 or a saw head 33A. Since the blade portion of the axe head 33 or the saw head 33A is provided parallel to the grip handle 10, the chopping or sawing job can be smoothly done when external force is applied to the grip handle 10.

In conclusion, the gardening tool of the invention can be joined by various tool heads with different functions at the front end of the grip handle 10 and, on the other hand, can be joined by tool heads that are positioned in different directions relative to the axial direction of the grip handle 10. Therefore, a user of the gardening tool does not have to carry a lot of gardening tools while working, and thus laborsaving and cost saving can be achieved.

What is claimed is:

1. A gardening tool with multiple interchangeable tool heads, including:
a pole-shaped grip handle, and a connecting head at one end of the grip handle, wherein a plurality of fastening holes is provided at the front side and the lateral side of the connecting head;
a first tool head, wherein a specific tool for specific usage can be provided on each of the two sides of the first tool head; besides, the blade portion of each specific tool is provided perpendicular to the grip handle; also, a connecting portion is provided between the two specific tools, and a plurality of fisheyes is provided on the connecting portion to be inserted in by a plurality of fastening elements so that the first tool head can be fastened onto the connecting head; and
a second tool head, which includes a sheet of connecting portion; also, a plurality of holes is provided on the connecting portion facing the corresponding fastening holes on the side face of the grip handle, wherein the fisheyes are to be penetrated by the fastening elements so that the second tool head can be fastened onto the side face of the connecting head.

2. The gardening tool with multiple interchangeable tool heads as claimed in claim 1, wherein the holes on the connecting portion are fisheyes, and the fastening elements are screws bolts.

3. The gardening tool with multiple interchangeable tool heads as claimed in claim 1, wherein the specific tool at one side of the first tool head can be a hoe, whereas the specific tool at the other side of the first tool head can be any of a pickaxe or a rake.

4. The gardening tool with multiple interchangeable tool heads as claimed in claim 1, wherein the blade portion of the second tool head is provided parallel to the grip handle and can be any of an axe or a saw.

5. The gardening tool with multiple interchangeable tool heads as claimed in claim 1, wherein the connecting head is made of metal, and the front end of the connecting head is a square shape; besides, in order to be fitted into the grip handle, the connecting head is formed extending from its front end to the opposite end in a diminishing manner so that the other end of the connecting head can be fitted into the grip handle.
